(19) United States
(12) Patent Application Publication
(10) Pub. No.: US 2025/0318522 A1
(43) Pub. Date: Oct. 16, 2025

(54) AGENT APPLYING APPARATUS, IMAGE FORMING APPARATUS, AND METHOD OF PRODUCING ANTIBACTERIAL OR ANTIVIRAL IMAGE

(71) Applicant: Konica Minolta, Inc., Tokyo (JP)

(72) Inventor: Toshiaki TOMINO, Tokyo (JP)

(21) Appl. No.: 19/170,495

(22) Filed: Apr. 4, 2025

(30) Foreign Application Priority Data
Apr. 11, 2024 (JP) 2024-064066

(51) Int. Cl. A01N 25/34; A01N 25/02; A01N 25/30; A01N 59/16; A01P 1/00

(52) U.S. Cl. CPC A01N 25/34; A01N 25/02; A01N 25/30; A01N 59/16; A01P 1/00

(57) ABSTRACT

An agent applying apparatus for applying a solution of an agent having an antibacterial or antiviral effect to a sheet. When the agent concentration of the agent solution is represented by C %, the effective application amount of the agent is represented by Tg/m², the basis weight of the sheet is represented by Mg, and the allowable increased water content of the sheet is represented by R %, the agent applying apparatus applies the agent solution so as to satisfy C≥10⁴T/MR.

### CROSS REFERENCE TO RELATED APPLICATIONS

The present invention claims priority under 35 U.S.C. § 119 to Japanese Application No. 2024-64066 filed on Apr. 11, 2024, the entire content of which is incorporated herein by reference.

### BACKGROUND

### Technological Field

The present invention relates to an agent applying apparatus, an image forming apparatus, and a method for producing an antibacterial or antiviral image.

### Description of Related Art

In recent years, there has been a demand for subjecting a printed matter (e.g., magazines, booklets, catalogs, leaflets, and calendars) to antibacterial treatment so that such a printed matter can be used in a clean state at all times.

For example, Japanese Unexamined Patent Publication No. 2023-70377 discloses a post-processing apparatus capable of applying an antibacterial agent diluted with water by a roller during conveyance of a printed matter.

### SUMMARY

An object of the present invention is to provide an agent applying apparatus capable of imparting antibacterial or antiviral effect to a sheet. Another object of the present invention is to provide an image forming apparatus including such an agent applying apparatus. Another object of the present invention is to provide a method for producing an image having an antibacterial or antiviral effect using such an image forming apparatus.

In order to achieve at least one of the above-described objects, an agent applying apparatus reflecting one aspect of the present invention is an agent applying apparatus that applies an agent solution having an antibacterial or antiviral effect onto a sheet, wherein, when an agent concentration of the agent solution is represented by C %, an effective application amount of the agent is represented by Tg/m², a basis weight of the sheet is represented by Mg, and an allowable increased water content of the sheet is represented by R %, the agent applying apparatus applies the agent solution so as to satisfy C≥10⁴T/MR.

In order to achieve at least one of the above-described objects, an image forming apparatus reflecting one aspect of the present invention includes the above-described agent applying apparatus.

In order to achieve at least one of the above-described objects, a method of producing an antibacterial or antiviral image reflecting one aspect of the present invention uses the above-described image forming apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates an overall configuration of an image forming apparatus according to an embodiment;

FIG. 2 illustrates an example of a configuration of an antibacterial agent applying unit (agent applying apparatus);

FIG. 3 illustrates an example of the configuration of a liquid circulation path;

FIG. 4 illustrates a spray mechanism;

FIG. 5 is a schematic diagram of a mixer;

FIG. 6 illustrates a mixing step in the mixer;

FIG. 7 is a graph which shows the relationship between the amount of an agent applied and the antibacterial activity value; and

FIG. 8A and FIG. 8B are graphs which show the relationship between the agent concentration and the antibacterial activity value.

### DETAILED DESCRIPTION OF EMBODIMENTS

Hereinafter, one or more embodiments of the present invention will be described with reference to the drawings. However, the scope of the invention is not limited to the disclosed embodiments.

In the following, a preferred embodiment of the present disclosure will be described in detail with reference to the accompanying drawings. In the following embodiment, a mode is described in which a sheet is coated with an antibacterial agent to impart antibacterial properties to the sheet. However, in general, an agent having antibacterial properties and an agent having antiviral properties include common components, and an agent having antibacterial properties may have antiviral properties. Therefore, in the following disclosure, “antibacterial” may be read as “antiviral”, or “antibacterial” may be read as “antibacterial and antiviral”. Similarly, “antibacterial” may be replaced with “antiviral”, and may be read as “antibacterial and antiviral”.

### Overall Configuration of Image Forming Apparatus

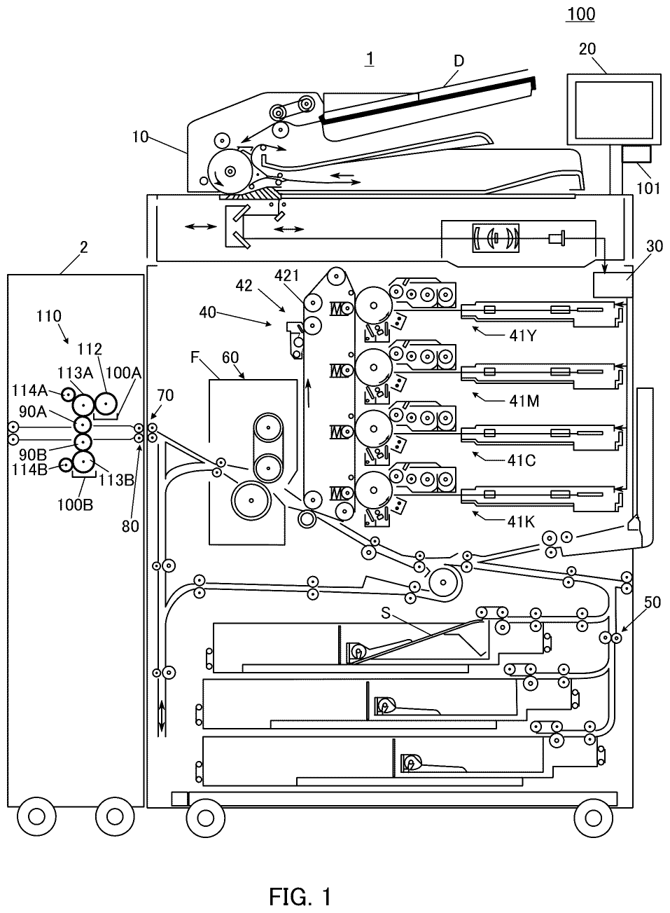

FIG. 1 illustrates an overall configuration of an image forming apparatus 100. The image forming apparatus 100 includes an image forming unit 1 and an antibacterial agent applying unit (agent applying apparatus) 2. In the image forming apparatus 100, the antibacterial agent applying unit 2 applies an antibacterial agent to the sheet on which the image has been formed and which has been conveyed from the image forming unit 1. Hereinafter, the image forming unit 1 and the antibacterial agent applying unit 2 will be described.

### Image Forming Unit

The image forming unit 1 is a unit that forms an image on a sheet S. In the present embodiment, the image forming unit 1 is an image forming unit of an intermediate transfer method utilizing an electrophotographic process technology.

The image forming unit 1 includes an image reading section 10, an operation display section 20, an image processing section 30, an image forming section 40, a sheet conveying section 50, a fixing section 60, a preprocessing side conveying section 70, and a control section 101.

The image reading section 10 is a portion that reads a document image. Based on the data of the image of the document D read by the image reading section 10, image processing is performed in the image processing section 30.

The operation display section 20 includes a liquid crystal display including, for example, a touch screen, and functions as a display part and an operation part.

The image processing section 30 includes a circuit and the like that performs digital image processing on input image data in accordance with initial settings or user settings. For example, the image processing section 30 performs tone correction on the basis of tone correction data (tone correction table) under the control of the control section 101. The image processing section 30 performs, on the input image data, not only the tone correction but also various types of correction processing such as color correction and shading correction, compression processing, and the like. The image forming section 40 is controlled on the basis of the processed image data.

The image forming section 40 forms a toner image on the basis of input image data. To be specific, the image forming section 40 includes toner image forming sections 41Y, 41M, 41C, and 41K for forming images with color toners of Y, M, C, and K components, respectively, and an intermediate transfer section 42. The toner image is primarily transferred to the intermediate transfer belt 421 of the intermediate transfer section 42 by each toner image forming section.

The sheet conveying section 50 conveys the sheet S to the image forming section 40. A toner image is secondarily transferred onto the sheet S conveyed to the image forming section 40 by the intermediate transfer belt 421.

The fixing section 60 heats and pressurizes the conveyed sheet S, on which the toner images have been secondarily transferred, at the fixing nip, thereby fixing the toner images on the sheet S. The fixing section 60 is disposed in the fixing device F.

The preprocessing side conveying section 70 conveys the sheet S on which the toner image is fixed to the antibacterial agent applying unit 2.

### Antibacterial Agent Applying Unit

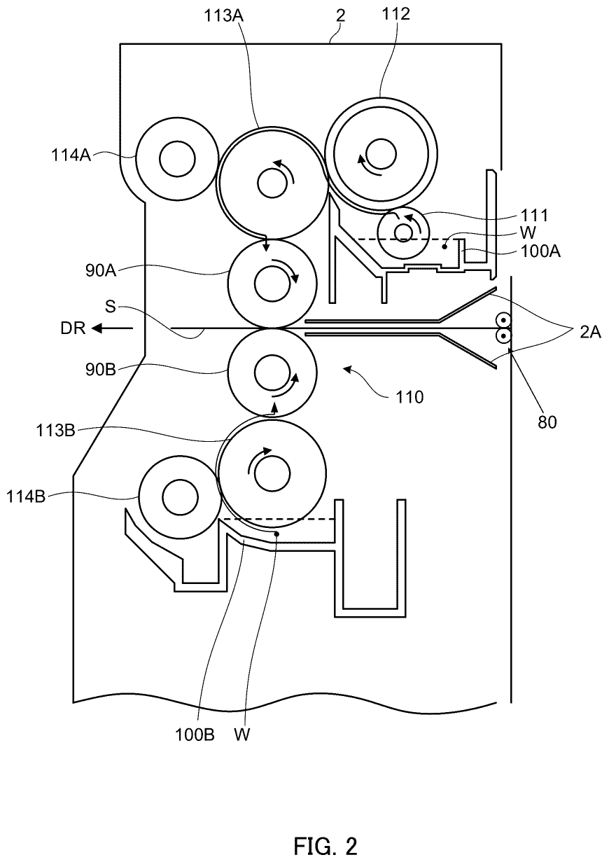

FIG. 2 is an enlarged view illustrating an example of the configuration of the antibacterial agent applying unit (agent applying apparatus) 2 in FIG. 1.

The antibacterial agent applying unit 2 includes a post-processing side conveying section 80, an upper application roller 90A, a lower application roller 90B, an upper tray 100A, a lower tray 100B, and a liquid supply section 110.

The sheet S delivered from the image forming unit 1 is conveyed into the antibacterial agent applying unit 2 through the entrance port 2A, and passes through between the upper application roller 90A and the lower application roller 90B. The antibacterial agent is applied to the sheet that has passed between the upper application roller 90A and the lower application roller 90B, and the sheet is conveyed to the outside of the antibacterial agent applying unit 2.

In the antibacterial agent applying unit 2, a post-processing side conveying section 80 is provided (see FIG. 1) which forms a conveyance path continuous with the preprocessing side conveying section 70 of the image forming unit, and the sheet S is conveyed in the antibacterial agent applying unit 2 by the post-processing side conveying section 80.

Thus, in the image forming apparatus 100 according to the present embodiment, the antibacterial agent applying unit 2 is disposed immediately downstream of the fixing section 60. This means that the step of applying the antibacterial agent to the sheet S is performed and dried in a state where the temperature of the sheet S is increased in the fixing section 60 (for example, about 80° C.). Thus, immediately after the step of applying the antibacterial agent to the sheet S, with the lapse of time, most of liquid components such as water and alcohol in the liquid applied to the sheet S evaporate, with the result that the powdery antibacterial agent remains on the sheet S. That is, thus, the powdery antibacterial agent can be allowed to remain on the surface of the sheet S uniformly and stably without allowing excessive liquid components such as water and alcohol to remain on the surface of the sheet S.

The upper application roller 90A is disposed on the sheet S and applies a solution of the agent (herein also simply referred to as “agent solution”) W to the upper surface of the sheet S. On the other hand, the lower application roller 90B is disposed under the sheet S and applies the agent solution W to the lower surface of the sheet S.

The upper application roller 90A and the lower application roller 90B are formed of a porous material, and can receive a supply of the agent solution from the surfaces thereof. Furthermore, the upper application roller 90A and the lower application roller 90B can apply the agent solution W to the front surface and the back surface of the sheet S in the process of pinching and conveying the sheet S.

The upper tray 100A is a storage for storing the agent solution W. The upper tray 100A is disposed above the sheet S and the upper application roller 90A and supplies the agent solution W to the upper application roller 90A.

The lower tray 100B is a storage to store the agent solution W. The lower tray 100B is disposed below the sheet S and the lower application roller 90B and supplies the agent solution W to the lower application roller 90B.

The liquid supply section 110 is a roller mechanism that supplies the agent solution W from the upper tray 100A and the lower tray 100B to the upper application roller 90A and the lower application roller 90B. The liquid supply section 110 includes a draw-up roller 111, an intermediate roller 112, an upper supply roller 113A, a lower supply roller 113B, a first draining roller 114A, and a second draining roller 114B.

The draw-up roller 111 is disposed in a state where a part thereof is immersed in the upper tray 100A, and draws up the agent solution W from the upper tray 100A. The agent solution W is supplied to the upper supply roller 90A via the draw-up roller 111, the intermediate roller 112, and the upper application roller 113A.

On the other hand, in the lower tray 100B, a lower supply roller 113B is disposed in a state where a part thereof is immersed, and draws up the agent solution W from the lower tray 100B. The agent solution W is supplied from the lower supply roller 113B to the lower application roller 90B.

The first draining roller 114A and the second draining roller 114B contact the upper supply roller 113A and the lower supply roller 113B, respectively, to remove a portion of the agent solution W.

In the antibacterial agent applying unit 2 having the above-described configuration, the liquid supply section 110 is configured to be able to adjust the application amount of the agent solution W with respect to the sheet S.

To be specific, the supply amounts of the agent solution W per unit time supplied to the upper application roller 90A and the lower application roller 90B depend on the draw-up amount of the agent solutions W per unit time draw up from the upper tray 100A and the draw-up amount of the agent solution W per unit time draw up from the lower tray 100B. These amounts depend on the liquid amounts (liquid levels) of the agent solutions W stored in the upper tray 100A and the lower tray 100B. That is, the amount of the agent solution W applied to the sheet S is adjusted by controlling the liquid amounts (liquid levels) of the agent solutions W stored in the upper tray 100A and the lower tray 100B.

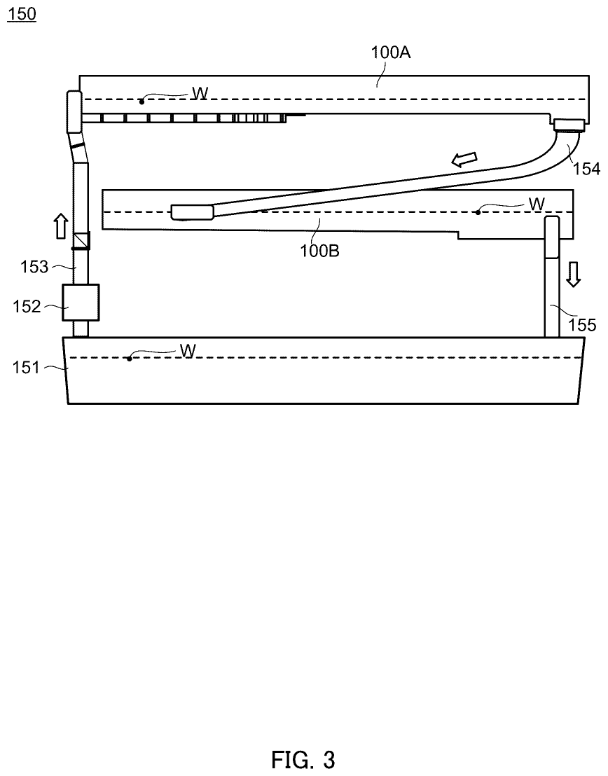

The liquid amounts (liquid levels) of the agent solution W stored in the upper tray 100A and the lower tray 100B are controlled by the output of the pump 152 that transfers the agent solution W from the tank 151 (see FIG. 3).

FIG. 3 illustrates an example of a configuration of the liquid circulation path 150. Note that in FIG. 3, the upper side of the page is the vertically upward direction and the lower side of the page is the vertically downward direction.

The liquid circulation path 150 is a flow path of the agent solution W for sucking up the agent solution W from the tank 151 storing the agent solution W and circulating the agent solution W to the upper tray 100A and the lower tray 100B, and includes a pump 152, a delivery path 153, a first return path 154, and a second return path 155.

The pump 152 pumps up the agent solution W stored in the tank 151 and sends the agent solution W to the delivery path 153. The delivery path 153 has one end connected to the pump 152 and the other end connected to an upper portion of the upper tray 100A and guides the agent solution W delivered from the pump 152 into the upper tray 100A. The first return path 154 has one end connected to a bottom portion of the upper tray 100A and the other end connected to an upper portion of the lower tray 100B and guides the agent solution W stored in the upper tray 100A into the lower tray 100B. The second return path 155 has one end connected to a bottom portion of the lower tray 100B and the other end connected to an upper portion of the tank 151 and guides the agent solution W stored in the lower tray 100B into the tank 151.

The liquid amounts (liquid levels) of the agent solution W stored in the upper tray 100A and the lower tray 100B are controlled by the number of rotations of the pump 152. That is, an amount of the agent solution W to be sent out by the driving of the pump 152 is stored in the upper tray 100A and the lower tray 100B. Note that the movement of the agent solution W from the inside of the upper tray 100A to the inside of the lower tray 100B and the movement of the agent solution W from the inside of the lower tray 100B to the inside of the tank 151 are due to the self-weight of the agent solution W. The operation of the pump 152 is controlled by, for example, the control section 101 of the image forming unit 1.

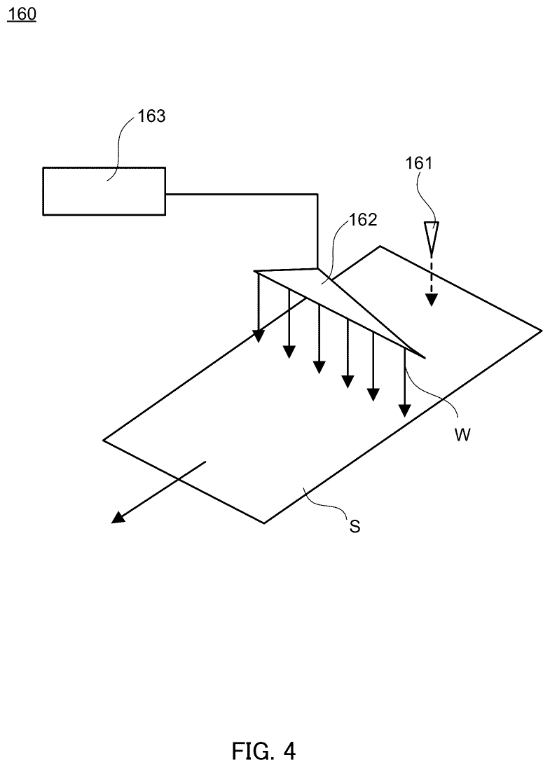

The agent solution may be applied with a spray instead of a roller. FIG. 4 illustrates a spray mechanism 160 in a case of spray-applying the agent solution W. As illustrated in FIG. 4, the spray mechanism 160 includes a sheet detection sensor 161, a spray ejection section 162, and a storage 163. When the sheet detection sensor 161 of the spray mechanism 160 detects the carrying-in of the sheet S, the agent solution is spray-applied from the spray ejection section 162. The agent solution W to be applied as a spray from the spray ejection section 162 is supplied from the storage 163.

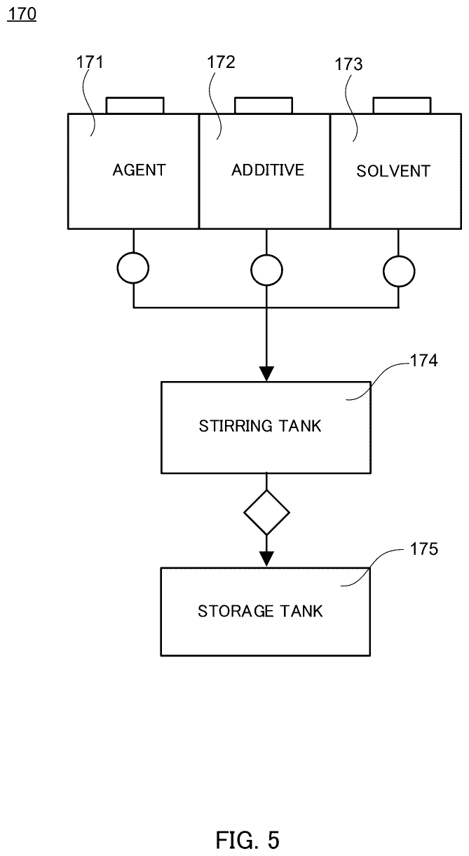

FIG. 5 illustrates a mixing mechanism 170 that mixes the agent, a solvent, and an additive (e.g., a surfactant or a thickener described below). The mixing mechanism 170 mixes the agent, the solvent, and the additive such that C≥10⁴T/MR is satisfied where an agent concentration of the agent solution is represented by C %. In the present embodiment, the mixing mechanism 170 includes an agent storage 171, an additive storage 172, a solvent storage 173, a stirring tank 174, and a storage tank 175 for an agent solution.

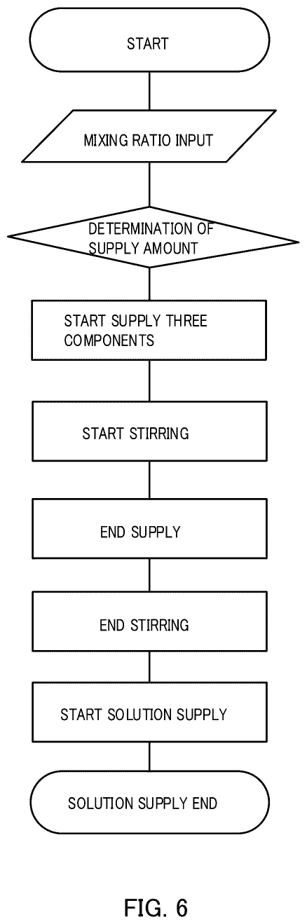

FIG. 6 illustrates a flow of mixing by the mixing mechanism 170. First, the mixing ratio between the agent, the solvent, and the additive is input on the basis of C determined on the basis of the above conditional expression (input mixing ratio). Then, the supply amounts of the agent, the solvent, and the additive are determined (determine supply amount). Next, supply of the three types of components, namely the agent, the solvent, and the additive, from the respective storages to the stirring tank is started (start supply of the three components). Next, stirring in the stirring tank is started (start stirring). Next, the supply to the stirring tank is completed (end the supply). Next, stirring in the stirring tank is completed (end the stirring). Next, the supply of the agent solution to the storage tank of the agent solution is started (start solution supply). Next, the supply of the agent solution is completed (end the solution supply). This flow may be controlled by, for example, the control section 101 described above.

### Application of Agent

When the agent concentration of the agent solution is represented by C %, the effective application amount of the agent is represented by Tg/m², the basis weight of the sheet is represented by Mg, and the allowable increased water content of the sheet is represented by R %, the image forming apparatus 100 applies the agent solution so as to satisfy C≥10⁴T/MR. Hereinafter, R and T in this conditional expression will be described, and C≥10⁴T/MR will be described.

### Allowable Increased Water Content: R %

The allowable increased water content is the amount of the agent solution that the sheet can contain. When the paper contains the agent solution so that the water content of the paper is equal to or less than the allowable increased water content, the sheet does not ripple. Therefore, from the viewpoint of preventing the occurrence of rippling in the sheet, it is preferable that the application of the agent solution to the sheet be performed at an allowable increased water content or lower.

The allowable increased water content can be expressed by the following relational expression.

$$Allowable increased water content ( \% ) = Limit water content ( \% ) - uncoated water content ( \% )$$

Here, the limit water content and the uncoated water content in the expression can be measured by using a water content meter (Moistrex MX8000 type, manufactured by Shinmei General Corp.).

As can be seen from this relational expression, the allowable increased water content represents the amount of an agent solution that a sheet can contain.

For example, when the sheet tends to absorb water, the allowable increased water content increases. Furthermore, for example, the allowable increased water content increases under an environmental condition in which the humidity is low. As described above, the allowable increased water content changes depending on the type of paper, environmental conditions, and the like.

Note that as described above, applying an agent to a sheet until the water content reaches the limit water content is achieved by adjusting the liquid levels in the upper tray 100A and the lower tray 100B of the image forming apparatus. Alternatively, it is achieved by adjusting the spray amount in the spray mechanism 160. Note that as described above, since the agent solution W is applied to the sheet at a temperature close to 80° C., the solvent of the agent solution evaporates, and the agent remains on the sheet S.

### Effective Application Amount of Agent: Tg/m²

The effective application amount of an agent is the amount of the agent per m² of a sheet required to have the antibacterial performance evaluated according to JIS Z 2801 2012. In particular, the effective application amount of the agent can be determined as follows: the agent is uniformly applied to a sheet by a PET contact method, and the sheet to which the agent is uniformly applied is evaluated for the antibacterial activity value on the basis of the JIS Z 2801 2012.

First, a 5 cm×5 cm polyethyleneterephthalate (PET) sheet is laid on a 5 cm×5 cm square petri dish. Next, a liquid agent is added onto the PET sheet so that the water content of the sheet becomes half of the allowable increased water content of the test piece (sheet) in the 5 cm×5 cm. Next, the test piece (sheet) of the 5 cm×5 cm is placed in the petri dish. Next, a solution of an agent having half of the remaining allowable water content is added onto the test piece. Next, a sheet of 5 cm×5 cm PET is placed on top of the agent solution. Then, the PET sheet is covered with a lid so as to be pressed and left for 96 hours to produce a sheet having antibacterial properties.

Note that sheets having various application amounts of the agent per area are manufactured using solutions of the agent having various agent concentrations (C).

The antibacterial activity value is measured according to JIS Z 2801 2012 using the sheet having antibacterial properties produced as described above, and the application amount of the agent at which the antibacterial activity value becomes 2 is used as the effective application amount Tg/m² of the agent.

### C≥10⁴T/MR

It is assumed that the agent concentration of the agent solution is C %, the effective application amount of the agent is Tg/m², the basis weight of the sheet is Mg, and the allowable increased water content of the sheet is R %. Here, the MRC is the amount of the agent that can be contained in 1 m² of a sheet, and in the case of MRC≥10⁴T, the antibacterial activity value of the sheet is 2 or more. Therefore, when the concentration of the agent is adjusted so as to satisfy C≥10⁴T/MR, the antibacterial activity value becomes 2 or more.

For example, assuming that the effective application amount of the agent is T=0.15 (g/m²), the basis weight of sheet is M=157 (g/m²), and the allowable increased water content is R=2.5 (%), the agent concentration in the agent solution is C=3.8 (%).

The type of the agent may be an organic agent or an inorganic agent.

An organic agent has an immediate effect and is relatively inexpensive. On the other hand, organic agents have problems that their effective periods are short, that they lack heat resistance, and that their antibacterial properties are reduced by UV rays.

On the other hand, an inorganic agent has high durability of effect and safety, and are less likely to be influenced by UV. On the other hand, inorganic agents are high in material cost, thus increasing the printing cost.

Examples of the organic agent include benzalkonium chloride, sodium linear alkylbenzene sulfonate, alkylglycoside, alkylamine oxide, benzethonium chloride, dialkyldimethylammonium chloride, polyoxyethylene alkyl ether, potassium fatty acid, and sodium fatty acid. These may be used alone or in combination. [symbol] Is included.

Examples of the inorganic agent include silver, copper, zinc, titanium oxide, silver zeolite, and antibacterial agents containing silver and titanium oxide. These may be used alone or in combination. Zeolite is a generic name for minerals having a skeleton structure composed of elements such as aluminum, silicon, and oxygen, and includes natural products and artificial products. Silver zeolite is used in many products as a raw material for generating antibacterial and antiviral effects by incorporating silver ions into zeolite. Titanium oxide exhibits antibacterial properties and antiviral properties due to a photocatalytic action under the influence of UV. Titanium oxide can more effectively exhibit an antibacterial effect in various environments by being used together with silver.

The agent solution may include a surfactant or thickener to disperse the agent in the solution.

The surfactant has hydrophilic and hydrophobic portions in the molecule, and thus exhibits a dispersing action or an emulsifying action of stabilizing immiscible substances such as water and oil. Examples of the surfactant include cationic surfactants, anionic surfactants, nonionic surfactants, anionic nonionic complex surfactants, amino acid surfactants, glycerol-based surfactants, and plant-derived surfactants such as saponin. Of these, cationic surfactants and saponin are not suitable because cationic surfactants generally has a high viscosity, and saponin generates much foam, and therefore surfactants other than these are preferred.

A thickener is a chemical substance that increases the viscosity of a liquid or solution, and is used as a dispersant for suppressing precipitation of inorganic agents. Examples of the thickener include xanthan gum, carrageenan, gelatin, cellulose gum, pectin, and acrylic acid-based polymers.

Examples of the solvent used for the agent solution include alcohol-based solvents and water. Since an inorganic agent is a powder, an alcohol solvent is generally used as a solvent in many cases. However, an alcohol-based solvent is not desirable because it may cause corrosion of metal parts in an image forming apparatus (for example, a printing machine) or chemical attack on resin parts. Therefore, water is used as a solvent, but an inorganic agent is a compound containing a metal element as a main component and is non-hydrophilic, and thus is easily precipitated in water, and it is preferable to improve dispersibility by mixing a surfactant or a thickener as an additive.

### EXAMPLES

Hereinafter, the present invention will be specifically described with reference to Examples, but the present invention is not limited to the following Examples.

### Allowable Increased Water Content: Measurement of R

First, agent solutions at various amounts were each applied to high-quality paper and coated paper to increase the water content, and whether or not rippling occurred was visually confirmed. The confirmed results are shown in Table 1. Note that the increased water content was measured using the above-described water content meter (Moistrex MX8000 type, manufactured by Shinmei General Corp.).

TABLE 1

Rippling

| Increased water | High-quality paper | Coated paper |
|---|---|---|
| content % | (basis weight: 157 g) | (basis weight: 157 g) |
| 0.5% | ∘ | ∘ |
| 1.0% | ∘ | ∘ |
| 1.5% | ∘ | ∘ |
| 2.0% | ∘ | ∘ |
| 2.5% | ∘ | x |
| 3.0% | x | x |
| 3.5% | x | x |

In Table 1, the case where the rippling did not occur is indicated by o, and the case where the rippling occurred is indicated by x. From Table 1, it is found that in the case of the high-quality paper, when the increased water content is 2.5% or less, it is equal to or less than the allowable increased water content, and in the case of the coated paper, when the increased water content is 2.00% or less, it is equal to or less than the allowable increased water content, and the rippling does not occur.

### Preparation of Sheet Having Antibacterial Effect

On the basis of Table 1, the agent solution was applied to the high-quality paper so that the increased water content was 2.5%, and the agent solution was applied to the coated paper so that the increased water content was 2.0%. Agent solutions with various concentrations were used so that the application amount of the agent became 0.05 g/m², 0.1 g/m², 0.15 g/m², 0.2 g/m², 0.25 g/m², 0.3 g/m², and 0.35 g/m².

### Measurement of Effective Application Amount

A sheet coated with the agent prepared as described above was used as a test piece, and the antibacterial activity value was measured based on the JIS Z 2801 2012. Specifically, the test piece was inoculated with a test bacterial liquid to evaluate the antibacterial effect.

A test bacterial liquid to be inoculated on a test piece was prepared as follows. That is, using a 1/500 bouillon medium prepared by diluting a nutrient bouillon medium 500 times, the number of E. coli cells was adjusted to 2.5×10⁵ to 10×10⁵ cells/mL, and the resultant was used as a test bacterial liquid.

The test piece is placed in a petri dish, and the test piece is inoculated with a test bacterial liquid of 0. 4 mL. The test piece inoculated with the test bacterial liquid was covered with a film of 4 cm×4 cm and cultured in an incubator at a temperature of 36° C. for 24 hours. After the culture, SCDLP medium 10 mL was added to the test piece to wash out the bacteria.

The viable cell count in the washed-out liquid was measured using a standard agar medium. Note that as a control, a test piece to which no agent was applied was used. This test piece was also subjected to the same operation, and the viable cell count was measured in the same manner.

An antibacterial activity value was calculated by the following equation using a test piece (antibacterial-treated test piece) to which an agent having antibacterial properties was applied and a test piece (untreated test piece) to which no agent having antibacterial properties was applied.

$$V = U - A$$

V: antibacterial activity value, U: logarithmic value of viable cell count of untreated test piece, A: logarithmic value of viable cell count of antibacterial-treated test piece

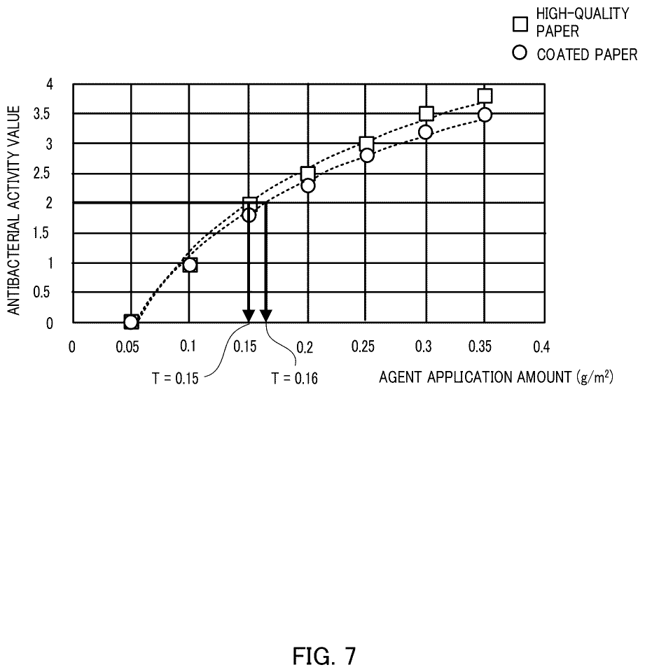

Here, when V, which is the antibacterial activity value, is 2.0 or more, the antibacterial-treated test piece can be evaluated to have sufficient antibacterial properties. FIG. 7 shows a graph in which the relationship between the test piece of each agent application amount and the antibacterial activity value is plotted. From this graph, the effective application amount T of the agent was obtained from the application amount of the agent at which the antibacterial activity value became 2.

That is, in the case of high-quality paper, the effective application amount of the agent was 0.15 g/m². On the other hand, in the case of coated paper, the effective application amount of the agent was 0.16 g/m². When the effective application amount T of the agent was substituted into the conditional expression to obtain C, C was 3.8% in the case of high-quality paper, and 5.1% in the case of coated paper. Table 2 shows numerical values of the conditional expressions.

TABLE 2

| | | High-quality | Coated |
|---|---|---|---|
| | | paper | paper |
| T | Effective application amount of | 0.15 | 0.16 |
| | agent (g/m²) | | |
| M | Basis weight of sheet (g/m²) | 157 | 157 |
| R | Allowable increased water content (%) | 2.5 | 2.0 |
| MR | Application amount of agent solution | 3.9 | 3.1 |
| | (g/m²) | | |
| C | Agent concentration (%) in agent | 3.8 | 5.1 |
| | solution | | |

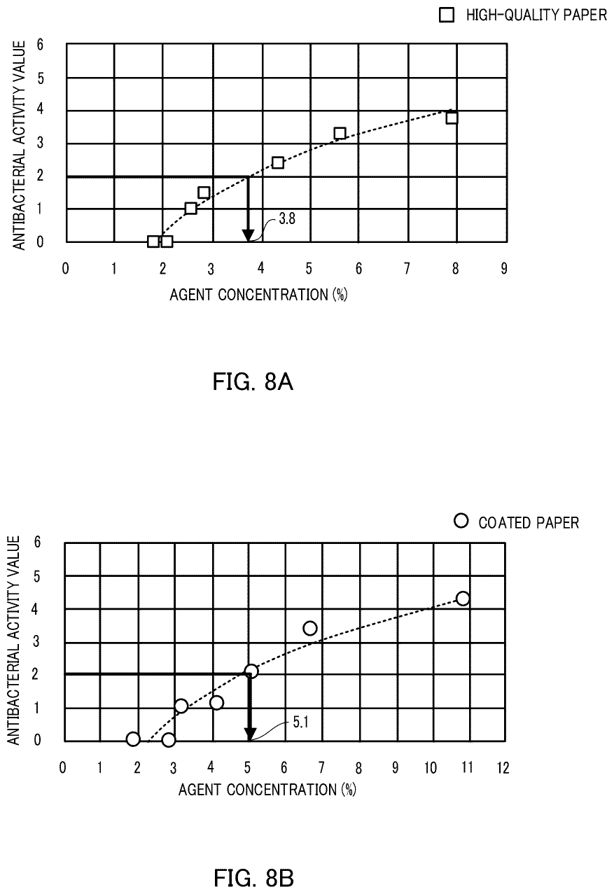

A sheet having antibacterial properties was prepared by the PET method as described above, and an image was formed using the image forming apparatus so as to satisfy the obtained agent concentration C of the agent solution, and whether each image has sufficient antibacterial properties was examined. The results are shown in FIG. 8A and FIG. 8B.

FIG. 8A illustrates the antibacterial activity value when an image was formed on high-quality paper using an image forming apparatus, and FIG. 8B illustrates the antibacterial activity value when an image was formed on coated paper. FIG. 8A and FIG. 8B each illustrate the antibacterial activity value when an image was formed while changing the concentration of the agent solution. From Table 2, in the case of high-quality paper, when the concentration of the agent solution is 3.8%, the antibacterial activity value is 2, and in the case of coated paper, when the concentration of the agent solution is 5.1%, the antibacterial activity value is 2. With respect to this antibacterial activity value, the results of FIG. 8A and FIG. 8B and the results of Table 2 substantially coincided with each other. Thus, it has been found that an image having a sufficient antibacterial power can be obtained when the conditional expression is satisfied.

### INDUSTRIAL APPLICABILITY

According to the present invention, it is possible to impart antibacterial properties or antiviral properties to a sheet. The present invention can impart antibacterial properties or antiviral properties to an image formed by, for example, an electrophotographic method.

Although embodiments of the present invention have been described in detail, it is clearly understood that the same is by way of example only and not limitation, the scope of the present invention should be interpreted by terms of the appended claims.

What is claimed is:

1. An agent applying apparatus that applies a solution of an agent having an antibacterial or antiviral effect to a sheet, wherein
when an agent concentration of the solution of the agent is represented by C %, an effective application amount of the agent is represented by Tg/m², a basis weight of the sheet is represented by Mg, and an allowable increased water content of the sheet is represented by R %,
the agent applying apparatus applies the solution of the agent so as to satisfy C≥10⁴T/MR.

2. The agent applying apparatus according to claim 1, wherein the agent is silver zeolite or an antibacterial agent containing silver and titanium oxide.

3. The agent applying apparatus according to claim 1, wherein the solution of the agent includes a surfactant or a thickener.

4. The agent applying apparatus according to claim 3, wherein the surfactant is an anionic surfactant, an anionic nonionic complex surfactant, an amino acid surfactant, or a glycerol-based surfactant.

5. The agent applying apparatus according to claim 3, wherein the thickener is xanthan gum, carrageenan, gelatin, cellulose gum, pectin, or an acrylic acid-based polymer.

6. The agent applying apparatus according to claim 1, wherein an application amount of the solution of the agent is adjusted by adjusting a liquid level of the solution in a storage that stores the solution of the agent.

7. The agent applying apparatus according to claim 1, comprising a mixing mechanism capable of adjusting a mixing ratio between the agent, an additive, and a solvent.

8. The agent applying apparatus according to claim 1, comprising a roller or a spray for applying the solution of the agent to the sheet.

9. An image forming apparatus, comprising the agent applying apparatus according to claim 1.

10. A method for producing an antibacterial or antiviral image, the method using the image forming apparatus according to claim 9.
